(19) United States
(12) Patent Application Publication
(10) Pub. No.: US 2004/0028427 A1
(43) Pub. Date: Feb. 12, 2004

(54) Toner supply container and unsealing member for unsealing the toner supply container

(75) Inventors: Tetsuo Isomura, Abiko-shi (JP); Yusuke Yamada, Moriya-shi (JP)

Correspondence Address: FITZPATRICK CELLA HARPER & SCINTO, 30 ROCKEFELLER PLAZA, NEW YORK, NY, 10112, US

(73) Assignee: Canon Kabushiki Kaisha, Tokyo (JP)

(21) Appl. No.: 10/422,977

(22) Filed: Apr. 25, 2003

(30) Foreign Application Priority Data
Apr. 26, 2002 (JP) 127694/2002 (PAT.

(51) Int. Cl. G03G 15/08

(52) U.S. Cl. 399/258

(57) ABSTRACT

A toner supply container detachably mountable to an image forming apparatus includes a container body for accommodating toner, a discharge opening for permitting discharge of the toner from the container body, a sheet for sealing the discharge opening and for being staved by an unsealing member provided in the image forming apparatus, and a rotational force receiving portion for receiving a rotational force for feeding the toner from the container body toward the discharge opening. After the sheet is staved by the unsealing member, the rotational force receiving portion is engaged with the unsealing member to be placed in a state capable of receiving the rotational force.

### FIELD OF THE INVENTION AND RELATED ART

The present invention relates to a toner supply container for supplying toner to an image forming apparatus which employs an electrostatic recording method or an electrophotographic method, and an unsealing member for unsealing the toner supply container.

In a conventional electrophotographic image forming apparatus such as an electrophotographic copying machine or a printer, fine particles toner is used as a developer. When the toner in a main body of the electrophotographic image forming apparatus is used up, the toner is supplied into the main assembly of the image forming apparatus by using a toner supply container.

Here, the electrophotographic image forming apparatus includes an electrophotographic copying machine, an electrophotographic printer, a facsimile machine, word processor or the like.

Since the toner is very fine powder, the toner has been accompanied with a problem such that toner particles are scattered during toner supply operation, thus resulting in contamination of an operator (user) or surroundings of the container. For this reason, there has been proposed and practiced a system in which a toner supply container is mounted in a main body of an image forming apparatus and toner is gradually discharged though a small opening of the toner supply container.

Any one of the above-described toner supply containers receives a driving force from the main body of an image forming apparatus to drive a feeding member in the toner supply container or the main body itself to discharge the toner. As for such a drive transmitting means, there are some methods. For example, there have been known methods such that gear portion is provided on an outer surface of a toner bottle (toner supply container), that end surface of the toner bottle is provided with a projection, and that a driving force is transmitted through a coupling portion of projections and grooves.

On the other hand, as a means for sealing an opening of a toner supply container, there has conventionally been ordinarily practiced a system in which a flexible film is heat-sealed to the opening of the toner supply container and a user unseals he flexible film by peeling off the flexible film with hand. Further, a method wherein a packing member is adhered to slidable shutter member which is openable and closable, and an opening of the toner supply container is sealed through the packing member, followed by pulling-out of the shutter member by a user to unseal the opening. In addition, it has been also performed that a capping member is press-fitted in an opening of the toner supply container and then the capping member is peeled out to unseal the opening.

In the conventional toner supply containers, the above-mentioned drive transmission means and the sealing means for sealing the opening are generally provided separately.

Further, in the main body of the image forming apparatus, means for transmitting a driving force to the toner supply container and means for unsealing the opening are generally provided as separate members.

However, the conventional methods have been accompanied with some technical problems.

First, in the cases of peeling-off of the flexible film heat-sealed to the opening of the toner supply container by the user and of pulling-out of the slidable shutter member, provided with the packing member for sealing the opening by the user, a considerable force is required to unseal the opening. Further, the user is required to directly operate the means for unsealing the opening. Accordingly, a heavy burden is imposed on the user and the operation itself is troublesome.

Further, as a force required for unsealing becomes larger, the toner is much liable to be scattered in response to the unsealing force, thus contaminating the user or the periphery of the main body of the image forming apparatus.

Secondly, the unsealing means for the opening and the driving force transmission means for the toner supply container are separately provided as described above. As a result, the feeding member of the toner supply container or the toner supply container itself is normally driven after the opening of the toner supply container is unsealed, but there is a possibility that the feeding member of the toner supply container or the toner supply container itself is accidentally driven without unsealing the opening, thus resulting in a state such that no toner is supplied for a while.

Thirdly, in the case where the feeding member is provided in the toner supply container and the driving force is transmitted from the apparatus main body to the feeding member by using the coupling portion of projections and grooves, the user accidentally turns the coupling portion to rotate the feeding member backward in some cases. If the feeding member is reversely rotated, the toner is pushed toward an opposite end of the opening within the toner supply container. As a result, a stress is applied to the accommodated toner, thus being capable of causing formation of bulky particles etc.

### SUMMARY OF THE INVENTION

An object of the present invention is to provide a toner supply container improved in usability.

Another object of the present invention is to provide an unsealing member capable of unsealing and driving the toner supply container with a simple structure.

These and other objects, features and advantages of the present invention will become more apparent upon a consideration of the following description of the preferred embodiments of the present invention taken in conjunction with the accompanying drawings.

### BRIEF DESCRIPTION OF THE DRAWINGS

FIG. 1 is a sectional view of an image forming apparatus (electrophotographic copying machine) used in the present invention.

FIG. 2 is a perspective view of the electrophotographic copying machine shown in FIG. 1.

FIG. 3 is a perspective view illustrating mounting of a toner supply container into the electrophotographic copying machine after a toner container exchange cover is opened.

FIG. 4 is a front view of the electrophotographic copying machine of FIG. 1.

FIG. 5 is a side view of the electrophotographic copying machine of FIG. 1.

FIG. 6 is a top plan view of the electrophotographic copying machine in which a toner container exchange cover is shown as being in an open position.

FIG. 7 is sectional views illustrating a toner supply container mounting operation, wherein (A) shows an initial stage of the mounting operation, (B) shows the state after the completion of the mounting operation, in Embodiment 1 of the present invention.

FIG. 8 is a partly broken perspective view showing an internal structure of a toner supply container according to Embodiment 1 of the present invention.

FIG. 9 is a partly broken perspective view showing another part of the internal structure of a toner supply container according to Embodiment 1 of the present invention.

FIG. 10 is a partly enlarged section of view of a sealing member 2, wherein (A) is a sectional view of the sealing member in the neighborhood of an opening of a toner supply container according to Embodiment 1 of the present invention, (B) is a side view as seen in a direction a of (A), (C)-1 is a side view showing an example of the sealing member provided with circular perforations, (C)-2 is a side view showing an example of the sealing member provided with a circular half cut portion, (D)-1 is a side view showing an example of the sealing member provided with cross-shaped perforations, and (D)-2 is a side view showing an example of the sealing member provided with a cross-shaped half cut portion.

FIG. 11 is a sectional view illustrating mounting of a temporary cap 5 to the opening.

FIG. 12 is a side view showing an engaging hole 3.

FIG. 13 is a perspective view of a staving member 20a and the sealing member 2 according to Embodiment 1 of the present invention.

FIG. 14 is a perspective view of a staving member 20a provided with an auxiliary staving member 20c and the sealing member 2.

FIG. 15 is a view of another staving member 21a an the sealing member 2, wherein (A) is a perspective view showing another staving member 21a provided with a driving force transmitting rib 21b, and (B) is a sectional view of the driving force transmitting rib 21b having a tapered surface and a driving force receiving rib 6 having a tapered surface.

FIG. 16 is a view of another staving member 22a and the sealing member 2, wherein (A) is a perspective view showing another staving member 22a provided with a driving force transmitting groove 22b, and (B) is a sectional view showing a state such that the sealing member 2 is staved by another staving member 22a to unseal the opening, and the driving force transmitting groove 22b and a driving force receiving rub 7 are engaged with each other to permit discharge of toner from a through hole 22c.

FIG. 17 is an explanatory sectional view of a state such that the toner supply container according to Embodiment 1 of the present invention is unsealed and the driving force transmitting member and the driving force receiving member are engaged with each other, wherein (A) is a state immediately after mounting of the toner supply container by a user, (B) and (B)′ are respectively a state that the sealing member 2 is staved by the staving member 20a to unseal the opening of the toner supply container, and (C) is a state that the toner supply container is further pushed into an apparatus main body to engage the staving member 20a in an engage hole 3.

FIG. 18 is a view showing a staving member 25a, a driving force transmitting rib 25b and a driving force receiving rib 12 according to Embodiment 2 of the present invention, wherein (A) is a perspective view, and (B) is a front view.

FIG. 19 is a view showing a staving member 26a, a driving force transmitting rib 26b and a driving force receiving groove 13 according to Embodiment 2 of the present invention, wherein (A) is a perspective view, and (B) is a front view.

FIG. 20 is sectional views illustrating a toner supply container mounting operation, wherein (A) shows an initial stage of the mounting operation, (B) shows the state after the completion of the mounting operation, in Embodiment 1 of the present invention.

FIG. 21 is a sectional view showing a toner supply container according to Embodiment 3 of the present invention.

FIG. 22 is an explanatory sectional view of a state such that the toner supply container according to Embodiment 3 of the present invention is unsealed and the driving force transmitting member and the driving force receiving member are engaged with each other, wherein (A) is a state immediately after mounting of the toner supply container by a user, (B) is a state that the sealing member 2 is staved by the staving member 20a to unseal the opening of the toner supply container, and (C) is a state that the toner supply container is further pushed into an apparatus main body to engage the staving member 20a in an engage hole 3.

FIG. 23 is a perspective view of a driving force transmitting portion according to Embodiment 4 of the present invention, wherein (A) is a view showing the driving force transmitting member provided with a mounting portion 23b, and (B) is a view showing the driving force transmitting member provided with a slit 24b and a mounting rib 24c.

FIG. 24 is a perspective view of the driving force transmitting member according to Embodiment 4 of the present invention, wherein (A) is a view showing the driving force transmitting member shown in FIG. 23(A) and a drive portion on the apparatus main body side, and (B) is a view showing the driving force transmitting member shown in FIG. 23(B) and a drive portion on the apparatus main body side.

FIG. 25 is a sectional view illustrating a state such that the driving force transmitting member shown in FIG. 23(B) according to Embodiment 4 of the present invention is mounted and engaged into the drive portion on the apparatus main body side, wherein (A) is a state before engagement (B) is a state that the driving force transmitting member is inserted into the drive portion of the apparatus main body and guided by a tapered surface of the drive portion, thus being elastically deformed to be pushed into the apparatus main body.

### DETAILED DESCRIPTION OF THE PREFERRED EMBODIMENTS

Hereinbelow, a toner supply container and an unsealing member according to the preferred embodiments of the present invention will be described in conjunction with the accompanying drawings.

(Embodiment 1)

In this embodiment, a toner supply container including a sealing member and a driving force receiving member is used.

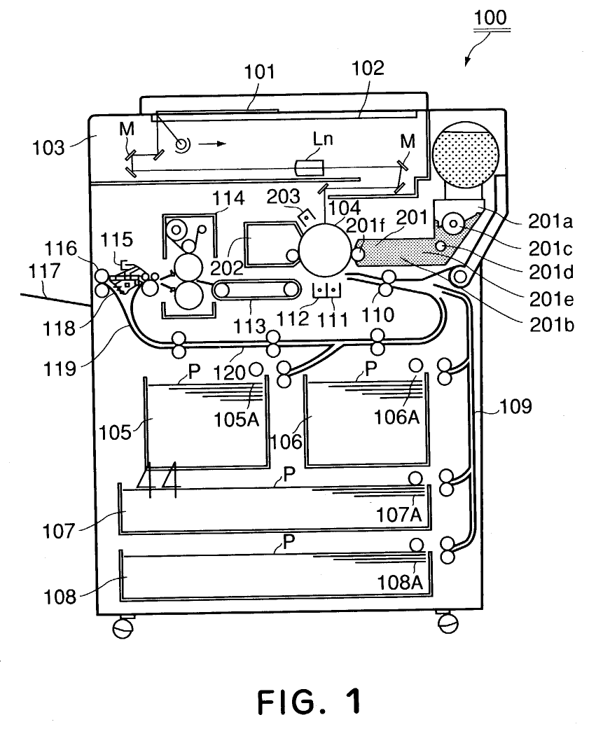

Referring to FIG. 1, the description will first be made as to an electrophotographic copying machine as an example of an electrophotographic image forming apparatus to which a toner supply container according to an embodiment of the present invention.

(Electrophotographic Image Forming Apparatus)

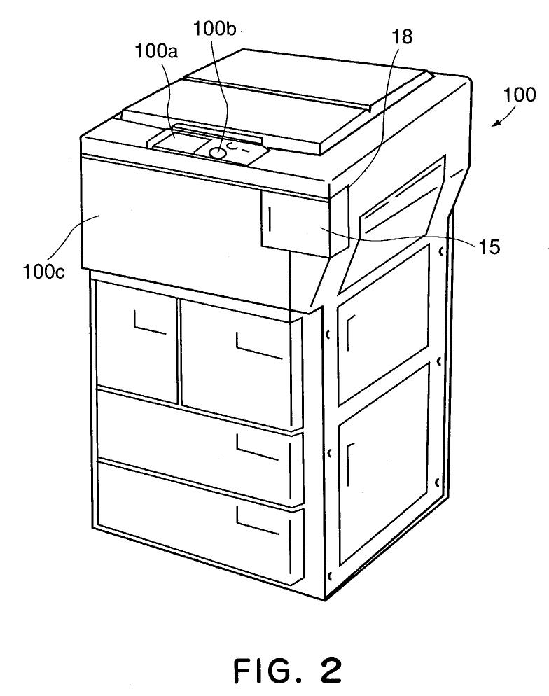

FIG. 1 shows an electrophotographic copying machine. An original 101 in a main body (main body of apparatus) 100 is placed on an original supporting platen glass 102. A light image corresponding to the image information of the original 101 is image on an electrophotographic photosensitive drum (image bearing member) 104 through a plurality of mirrors M and a lens Ln of an optical portion 103. On the basis of selection by the user on an operating portion 100a shown in FIG. 2 or on the basis of automatic selection in accordance with the paper size of the original 101, an optimum sheet P is selected from the cassettes 105, 106, 107, 108. The recording material is not limited to the sheet of paper, but may be an OHP sheet, for example.

A single sheet P supplied from one of separating devices 105A, 106A, 107A, 108A, is fed to registration rollers 110 by way of a feeding portion 109, and the sheet P is fed to the transfer portion by the registration rollers 110 in synchronism with the rotation of the photosensitive drum 104 and the scanning timing of the optical portion 103. In the transfer portion, a toner image formed on the photosensitive drum 104 is transferred onto the sheet P by the transfer discharger 111. The sheet P now having the transferred toner image is separated from the photosensitive drum 104 by a separation discharger 112.

The sheet P is fed into a fixing member 114 by a feeding member 113. In the fixing member 114, the toner image is fixed on the sheet P by heat and pressure. Thereafter, the sheet P is passed through a discharged sheet reversing member 115 and discharged to a sheet discharge tray 117 by sheet discharging rollers 116 in the case of a one-sided copy mode. In the case of a two-sided copy mode, the sheet P is refed to the registration rollers 110 through sheet refeeding paths 119, 120, under the control of a flapper 118 provided in the discharged sheet reversing member 115. Then, the sheet is fed similarly to the case of the one-sided copy mode, and is finally discharged to the sheet discharge tray 117.

In the case of a superimposed copy mode, the sheet P is temporarily and partly discharged by the sheet discharging rollers 116 through the discharged sheet reversing portion 115. Thereafter, at the timing when the trailing edge of the sheet passes by the flapper 118 while it is still nipped by the sheet discharging rollers 116, the flapper 118 is controlled, and the sheet discharging roller 116 is rotated in the reverse direction, so that it is refed into the main body 100. Thereafter, the sheet is fed to the registration rollers 110 through the sheet refeeding portions 119, 120, and then the sheet is processed similarly to the case of the one-sided copy mode. It is finally discharged to the sheet discharge tray 117.

In the main body 100 of apparatus, there are provided a developing device 201, a cleaning device 202, a primary charger 203 and so on, around the photosensitive drum 104.

An electrostatic latent image is formed by exposing the photosensitive drum 104 uniformly to the image light corresponding to the image information of the original 101 in the optical portion 103. The electrostatic latent image is developed with toner by the developing device 201. In order to supply the toner (developer) into the developing device 201, a toner supply container 1 is detachably mountable by the user into the main body 100 of apparatus.

The developing device 201 comprises a toner hopper 201a and a developing device 201b. The toner hopper 201a is provided with a stirring member 201c for stirring the toner supplied from the toner supply container 1. The toner stirred by the stirring member 201c is supplied into the developing device 201b by a magnet roller 201d. The developing device 201b comprises a developing roller 201f and a feeding member 201e. The toner fed from the toner hopper 201a by the magnet roller 201d is fed to the developing roller 201f by the feeding member 201e, and is supplied to the photosensitive drum 104 by the developing roller 201f.

The cleaning device 202 functions to remove the toner remaining on the photosensitive drum 104. The primary charger 203 functions to electrically charge the photosensitive drum 104.

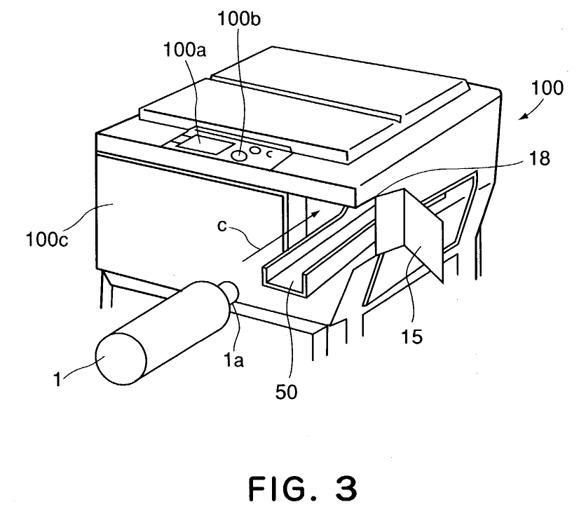

As shown in FIG. 3, when the user opens a front cover 15 for exchange of the toner supply container which is a part of an outer casing shown in FIG. 2, a container receiving tray 50 which is a part of mounting means is drawn out to a predetermined position by an unshown driving system. The user places the toner supply container 1 on the container receiving tray 50. When the user takes the toner supply container 1 out of the main body 100 of the apparatus, the container receiving tray 50 is drawn out, and the toner supply container 1 is taken out of the tray 50.

The front cover 15 is provided exclusively for mounting and demounting (exchange) of the toner supply container 1, and therefore, it is opened and closed only for the purpose. When the maintenance operation for the main body 100 of the apparatus is to be carried out, the front cover 100c is opened.

The toner supply container 1 may be directly mounted to the main body 100 of the apparatus without using the container receiving tray 50, and may be taken out.

(Exchanging Method for Toner Supply Container)

Next, a mounting method and a supply operation of the toner supply container of the present invention will be described.

In this embodiment, exchange of the toner supply container 1 is performed by the user in the following manner.

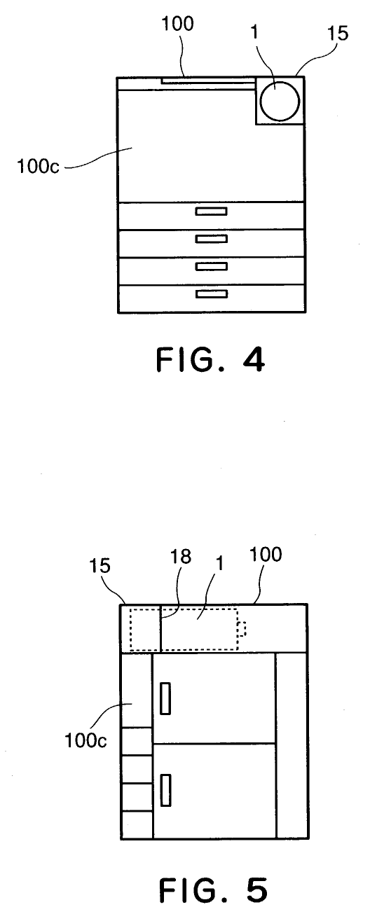

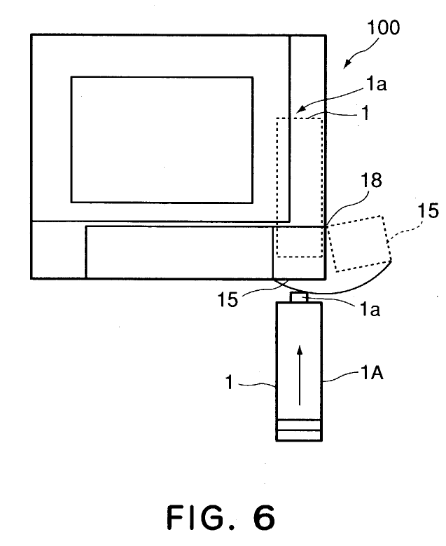

First, the front cover 15 which is in the closed state as shown in FIGS. 2, 4 and 5 is rotated about a hinge 18 to an open position indicated by a broken line in FIG. 6 as shown in FIGS. 3 and 6.

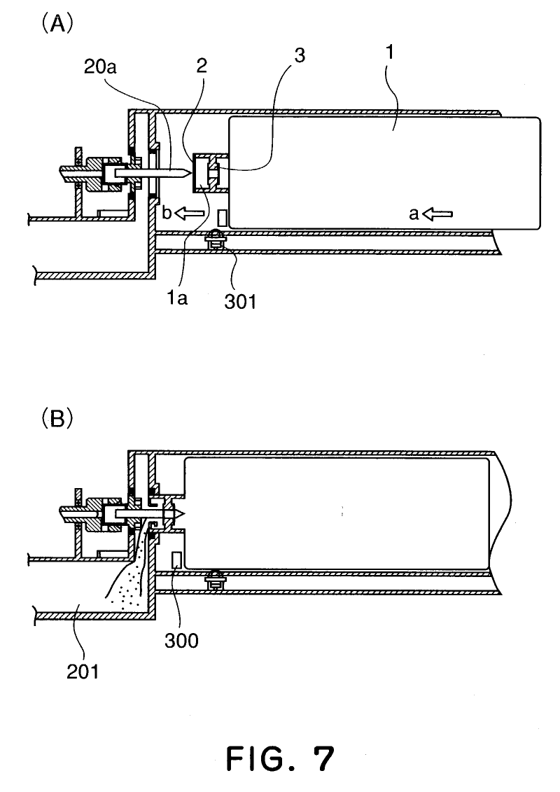

Thereafter, the user inserts a new toner supply container 1 into the apparatus main body 100 in a direction of an arrow a shown in (A) of FIG. 7 which shows a state immediately after the insertion. In this instance, the toner supply container is is provided with an opening 1a at a portion (spout) extended from a part of an end face of the toner supply container 1, and the opening 1a is sealed with a sealing member 2 of a resin film as a sheet.

Then, the user closes the front cover 15. In interrelation with the action of closing the front cover 15, a sliding member 300 is slided, so that the toner supply container 1 is moved in a direction of an arrow b in (A) of FIG. 7. As a result, the sealing member 2 which seals the opening 1a is staved by a staving member 20a provided on the apparatus main body side to unseal the opening 1a, and an engage hole 3 on the toner supply container 1 side and the staving member 20a on the apparatus main body side are engaged with each other to allow driving force transmission.

The staving member 20a also functions as a driving force transmitting member and has a cross section having a noncircular shape corresponding to the engage hole 3.

Further, at the time of engagement between the engage hole 3 and the staving member 20a, it is necessary to effect (phase) alignment. Means therefor will be described hereinafter.

In the engagement state, when a motor (not shown) is driven, a rotational force (driving force) is transmitted from the staving member 20a to the engage hole 3 of the toner supply container 1, thus rotating the toner supply container 1. The toner supply container 1 is rotatably supported by a receiving roller 301, so that the toner supply container 1 is capable of being smoothly rotated even at a slight torque. The receiving roller 301 is disposed at 4 points constituting a saddle for the toner supply container 1. As described above, the toner accommodated in the toner supply container 1 is successively discharged from the opening 1a by the rotation of the toner supply container 1, thus permitting supply of the toner into the developing device 201 on the apparatus main body side.

(Toner Supply Container)

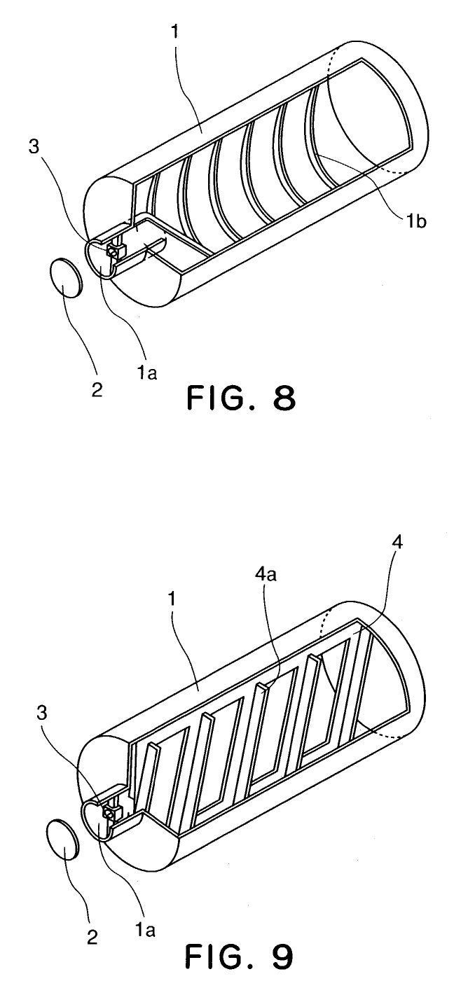

The toner supply container 1 used in this embodiment will be explained with reference to FIG. 8.

FIG. 8 is a partly broken perspective view of an example of the toner supply container 1 of this embodiment.

The toner supply container 1 is generally cylindrical, and one end thereof is provided substantially at a center with an opening 1a by a projected portion as spout. The diameter of the opening 1a is smaller than the diameter of the cylindrical portion of the main body of the toner supply container 1. The opening 1a is provided with a sealing member 2 for sealing the opening 1a, and is unsealed by staving the sealing member 2 with the staving member 20a. Inside the sealing member 2, an engage hole 3 for receiving a driving force from the apparatus main body side is provided.

The engage hole 3 is engaged with the staving member 20a disposed on the apparatus main body side and functions to transmit the rotational driving force to the toner supply container 1. The structures of the engage hole 3 and the staving member 20a will be described in detail hereinafter.

The internal structure of the toner supply container 1 will be described.

As described in the foregoing, the toner supply container 1 is generally cylindrical in shape and is disposed generally horizontally in the main body 100 of apparatus. It is rotated by the main body 100 of apparatus. An inside of the toner supply container 1 has a projection 1c in the form of a rib which extends helically. When the toner supply container 1 rotates, the toner is fed in the axial direction along the helical projection 1c, and the toner is discharged through the opening 1a formed at an end face of the toner supply container 1.

The internal structure of the toner bottle 1 according to the present invention is not limiting, and the configuration or the structure may be any as long as the toner can be discharged by rotation of the toner supply container 1. The main body of the toner supply container is not limited to that described in the foregoing. For example, it may have a feeding member such as a rotation screw or the like for feeding the toner, and the feeding member is driven by a rotational driving force received by the sealing member from the staving member provided to the image forming apparatus main body, while the toner supply container is fixed (not rotatable) on the main body of the image forming apparatus.

The feature of this embodiment is in the structure of the driving force transmitting portion for connection of the sealing member of the toner supply container 1 with the main body 100 of the apparatus with respect to the toner supply container for discharging the toner by driving the toner supply container 1. Therefore, the internal structure of the toner supply container 1 may be any, and the toner supply container may have a helical projection 1c on the inner surface of the toner supply container.

For example, the internal structure of the bottle may be modified as shown in FIG. 9. In this modified example, there is provided in the main body of the toner supply container a buffle member generally in the form of a plate. The surface of the buffle member has, on a surface, a plurality of inclined projections 4a which are inclined with respect to the direction of the axis of the toner supply container 1. One end of one of the inclined projections 4a extends to a neighborhood of the opening 1a. The toner is finally discharged from the inclined projection 4a through the opening 1a. By the rotation of the toner supply container 1, the toner is scooped by the buffle member 4 and then falls sliding on the surface of the buffle member 4. Because of the inclination of the inclined projections 4a, the toner is advanced toward the front side of the toner supply container 1. By repeating this operation, the toner in the toner supply container is gradually fed to the opening 1a while being stirred, and is discharged therethrough.

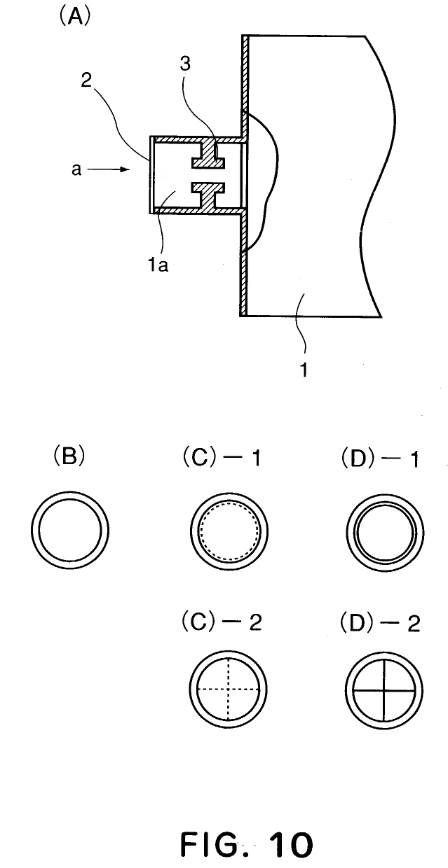

Next, the sealing member 2 will be described in detail with reference to FIG. 10.

In FIG. 10, (A) is a sectional view of a portion of the toner supply container 1 in the vicinity of the opening 1a for toner supply, and (B) is a side view as seen in a direction of an arrow a of (A).

The sealing member 2 is attached to an end o the opening 1a so as to seal the opening 1a, and comprises a film which is formed of a material and has a layer structure and a thickness, as shown in Table 2 below.

TABLE 1

| Layer structure | Material* | Thickness |
|---|---|---|
| 1 st: surface layer | PET | 16 μm |
| 2 nd: support layer | ONy | 25 μm |
| 3 rd: cushion layer | LDPE | 30 μm |
| 4 th: adhesive layer | EVA | 40 μm |

*PET: polyester film
ONy: biaxially-oriented nylon film
LDPE: low-density polyethylene film
EVA: sealant (ethylene vinyl acetate) film

The above-structured sealing member 2 of the four-layered film is cut into a size which is somewhat larger than the opening 1a and is applied to the opening 1a by a heat sealer for that purpose so as to seal the opening 1a.

Further, the sealing member 2 may be provided with an easy cut portion, such as perforations or a half cut portion (provided by partly thinning the film by means of a laser), in order to reduce an unsealing strength. The shapes of the perforations and the half cut portion are not particularly limited but may be, e.g., circular shapes as shown in (C)-1 and (D)-1 of FIG. 10 and cross shapes as shown in (C)-2 and (D)-2 of FIG. 10. In order to reduce the size of a part of the film remaining around the opening 1a as small as possible after the sealing member (film) 2 is staved by the staving member 20a, the shape of the easy cut portion may preferably be designed to provide a staved cross-sectional area larger than a cross-sectional area of the staving member 20a (so as to range a region larger than an area of a portion of the film contacting the staving member 20a). As a result, it becomes possible to enlarge a substantial cross-sectional area of the opening 1a for permitting discharge of toner as large as possible after the opening 1a is unsealed by the staving member 20a, and it is possible to enhance a discharge performance.

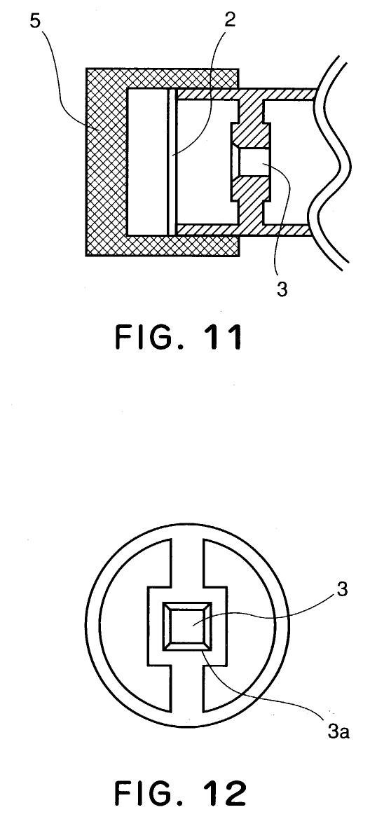

In this embodiment, the film having the sealant (adhesive) layer as a lowermost layer closer to the toner supply container is used as the sealing member. However, in the above-mentioned cases of using the perforations, the half cut portion and the elastic member, it is possible to reduce the unsealing strength but on the other hand, there is possibility that the resultant sealing member is erroneously unsealed in, e.g., a distribution stage to leak toner. For this reason, a temporary cap 5, as shown in FIG. 11, which is mounted to the opening 1a immediately before the use of the toner supply container 1 may be used. The temporary cap 5 is press-fitted and fixed at an outer peripheral surface of the opening 1a.

Then, the engage hole 3 will be described in detail with reference to FIG. 12.

FIG. 12 is a side view as seen from the outside (front) of the toner supply container 1.

The engage hole 3 is located substantially in alignment with a central axis line of the opening 1a and has a shape corresponding to a driving force transmitting member (the staving member 20a) provided to the apparatus main body but is somewhat larger than the staving member 20a. In this embodiment, the shape of the staving member 20a is intended to represent a sequence pole, thus being a square (rectangle) in cross section. Further, the engage hole 3 is fixed to the toner supply container 1, and the driving force transmitting member disposed on the apparatus main body side is engaged in the engage hole 3, thus permitting transmission of the driving force from the apparatus main body side to the toner supply container 1 to rate the toner supply container 1. As a result, the toner is discharged from the toner supply container 1.

In this embodiment, it is necessary to effect (phase) alignment of the staving member 20a (located on the apparatus main body side) with the engage hole 3. Hereinbelow, alignment means therefor will b described.

The toner supply container 1 is provided with a mark at a predetermined position in advance. When all the toner is discharged from the toner supply container 1 and the toner supply container 1 is replaced with new one, the toner supply container 1 can be taken out of the apparatus main body only after the mark is automatically or manually aligned with a certain position. Further, the new toner supply container 1 cannot be inserted into the apparatus main body unless the mark is aligned with the take-out position. In this way, the alignment of the staving member 20a with the engage hole 3 is performed.

Further, it is also possible to effect the alignment only by changing a tip shape of the staving member 20a from the pyramid shape to a cone shape. By changing the tip shape to the cone shape, during the engagement of the staving member 20a in the engage hole 3, the toner supply container 1 or the staving member 20a is guided to a position being in phase with the other member and then is rotated, thus effecting the (phase) alignment of the staving member 20a and the engage hole 3.

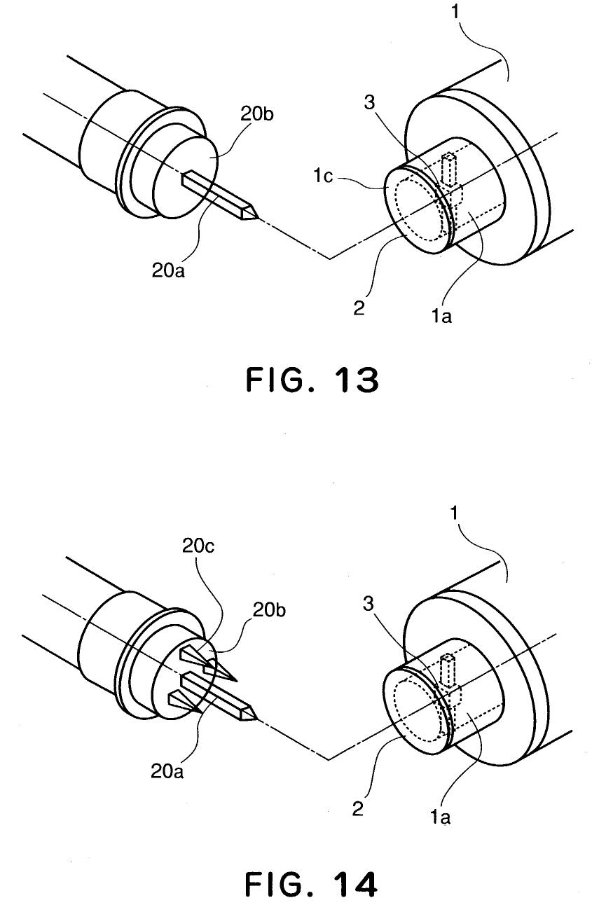

The staving member 20a will be described in detail with reference to FIG. 13.

In this embodiment, as described above, the staving member 20a also functions as the driving force transmitting member and is a square pole having a pyramid tip shape. The staving member 20a has a length such that an end face 20b of the apparatus main body does not contact an opening end face 1c even if the staving member 20a is engaged in the engage hole 3.

Although this embodiment employs a single staving member, the staving member 20a may be used in combination with a plurality of auxiliary staving members 20c as shown in FIG. 14.

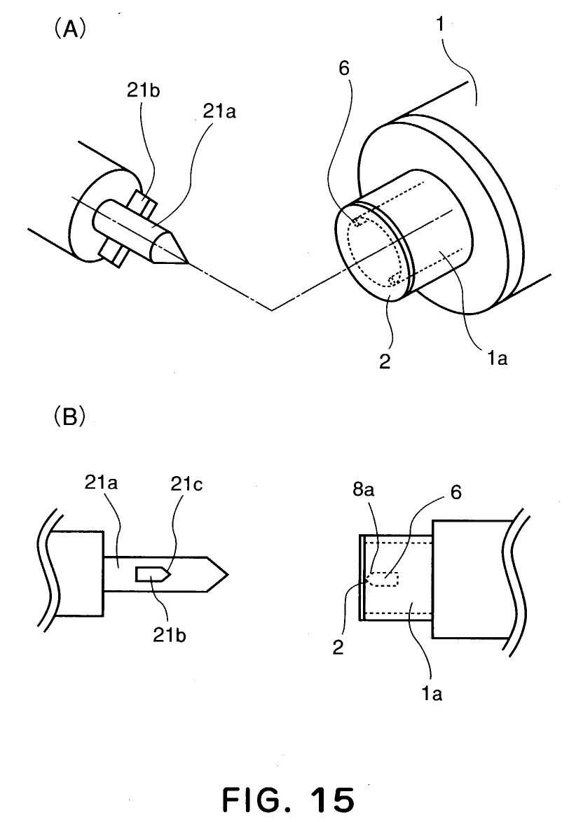

Further, as shown in (A) of FIG. 15, it is possible to use a staving member 21a (which is cylindrical in this case since it is not intended to transmit the driving force) provided with a driving force transmitting rib 21b. In this case, a driving force receiving rib 6 corresponding to the driving force transmitting rib 21b is provided to the toner supply container 1. In (A) of FIG. 15, in order to eliminate the need for alignment, the driving force transmitting rib 21b and the driving force receiving rib 6 have tapered surfaces 21c and 6a at their tip portions, respectively.

Further, in the case of the structure shown in FIG. 15, it is possible to remove a film, remaining around a discharge port of the opening, which narrows a cross-sectional area for toner discharge, by the driving force transmitting rib 21b after the film is staved by the staving member 21a. The removal of the film is performed by relative rotation of the driving force transmitting rib 21b and the driving force receiving rib 6 until these ribs are engaged with each other at the time of start of rotational drive. In this respect, the structure shown in FIG. 15 is performed compared with those shown in FIGS. 13 and 14. Accordingly, it is preferable that a degree ∘ protrusion of the driving force transmitting rib 21b from the peripheral surface of the staving member 21a is designed to approach an inner diameter of the opening 1a as close as possible.

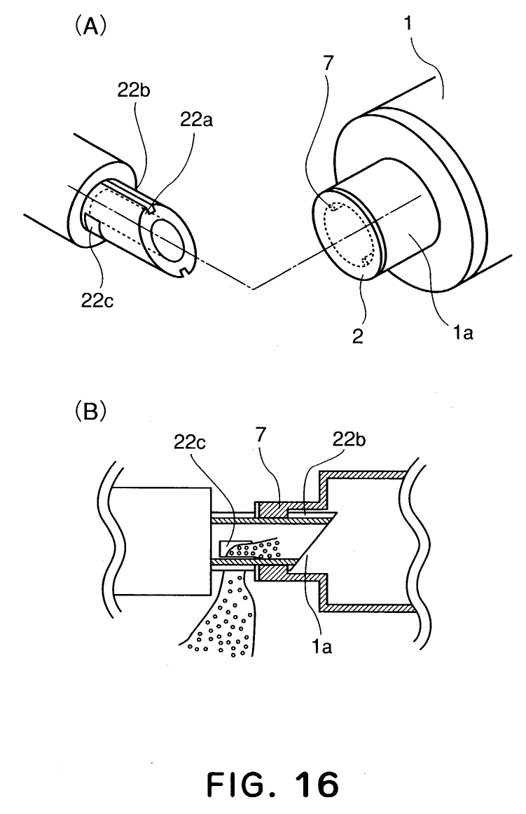

Further, it is also possible to employ a structure such that a pipe-shaped staving member 22a is provided with a driving force transmitting groove 22b as shown in (A) of FIG. 16. In this case, at the opening 1a of the toner supply container 1, a driving force receiving rib 7 is provided. In such a structure, although it is necessary to effect alignment of the driving force transmitting groove 22b located on the apparatus main body side with the driving force receiving rib 7 located on the toner supply container side, the driving force transmitting means on the apparatus main body side can be improved in strength, thus leading to a high durability. The pipe-shaped staving member 22a is designed to have an outer diameter slightly smaller than an inner diameter of the opening 1a. Further, the transmitting member 22a is provided with a through hole 22c at a portion which does not engage with the opening 1a when the toner supply container 1 is mounted to the apparatus main body.

FIG. 16(B) shows a state after the engagement.

Referring to FIG. 16(B), the sealing member 2 is staved to unseal the opening 1a and toner passes through the inside of the pipe-shaped staving member 22a and is supplied to the apparatus main body through the through hole 22c.

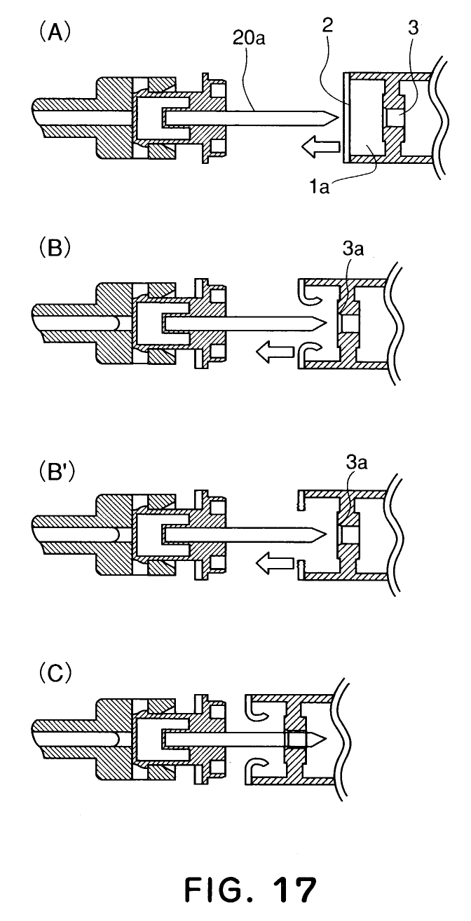

Next, a state of engagement of the staving member 20a with the engage hole 3 will be described with reference to FIG. 17.

FIG. 17(A) shows a state of the staving member 20a, the sealing member 2 and the engage hole 3 when the user opens the front (exchange) cover 15 of the apparatus main body 100 and sets a new toner supply container 1 in the apparatus main body 100. In this state, the staving member 20a is located on the front side of the sealing member 2, and the sealing member 2 is still in an unsealed state that the front cover 15 is not yet closed.

FIG. 17(B) shows a state of the staving member 20a, the sealing member 2 and the engage hole 3 when the front cover 15 is almost half closed and the toner supply container 1 is almost half closed and the toner supply container 1 is almost half pushed into the apparatus main body by the sliding member 300 shown in FIG. 7. In this state, the sealing member 2 is staved by the staving member 20a to unseal the opening 1a.

FIG. 17(B′) shows an unsealing state in the case of using an elastic member as the sealing member 2. By the use of the elastic member, the opening 1a is unsealed in an area larger than the case of using the sealing member shown in FIG. 17(B). In this way, although a part of the sealing member 2 is staved by the staving member 20a in such a state that the elastic film is held under tension, the elastic film as the sealing member 2 is shrunk by the elastic force of the film. Accordingly, the structure shown in (B′) of FIG. 17 is particularly preferred in that it is possible to enlarge a substantial cross-sectional area for toner discharge as large as possible.

FIG. 17(C) shows a state of the staving member 20a, the sealing member 2 an the engage hole 3 when the front cover 15 is completely closed, and the toner supply container 1 is completely pushed into the apparatus main body by the sliding member 300 shown in (B) of FIG. 7. In this state, the sealing member 2 is staved by the staving member 20a to unseal the opening 1a, and the staving member 20a is completely engaged in the engage hole 3. As shown in (C) of FIG. 17, in such a state that the staving member 20a is completely engaged in the engage hole 2, the staving member 20a is sufficiently long, so that the opening 1a and the end face of the driving force transmitting member of the apparatus main body are sufficiently distant from each other to permit supply of the toner through such a distant region.

As described above, the opening 1a is unsealed and the driving force from the apparatus main body can be transmitted to the toner supply container 1, so that the toner supply container 1 is rotated to supply the toner from the toner supply container 1 to the developing device 201 via the unsealed opening 1a.

As a result, according to this embodiment, it is possible to prevent such an operation that the toner supply container 1 is driven without accidentally unsealing the sealing member 2.

(Embodiment 2)

This embodiment is identical to Embodiment 1 except that a driving force receiving member is disposed outside the opening 1a.

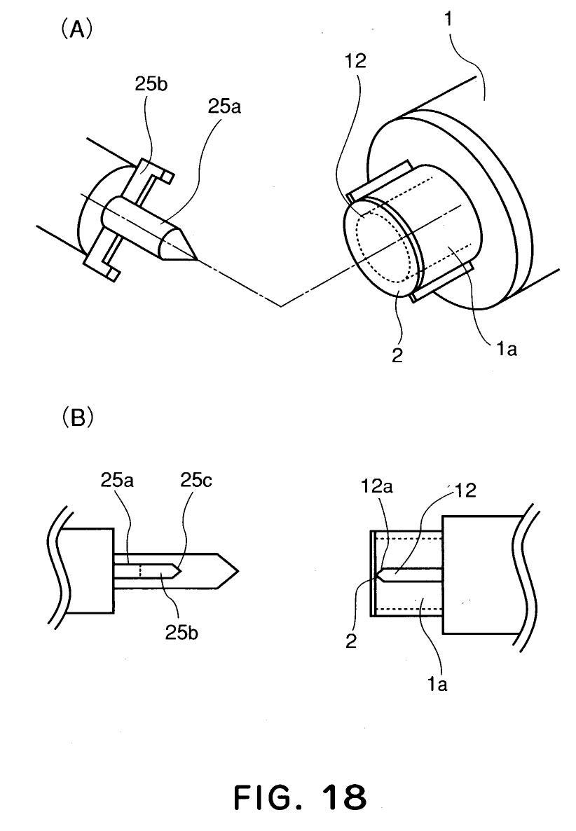

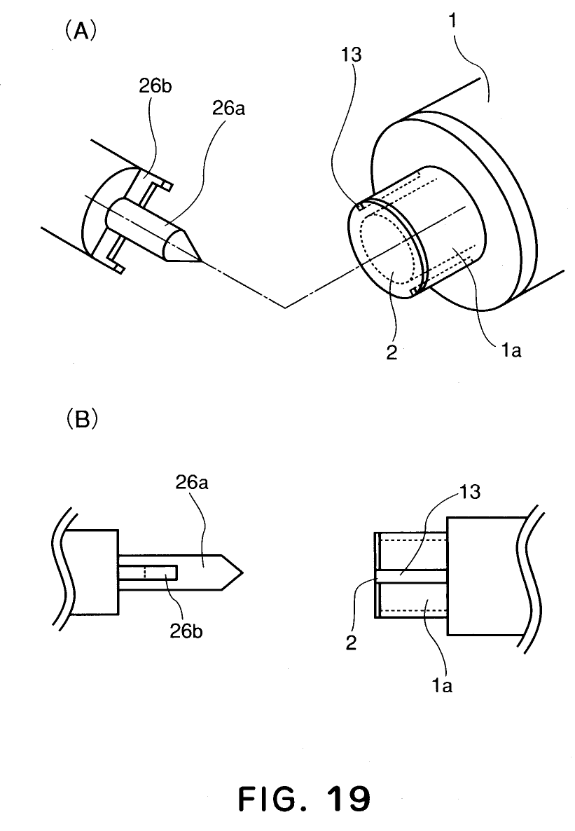

This embodiment will be described in detail with reference to FIGS. 18 and 19.

FIG. 18(A) is a perspective view of a toner supply container 1 provided with an opening 1a having a driving force receiving rib 12 at a peripheral surface of the opening 1a, and a staving member 25a provided with a driving force transmitting rib 25b. FIG. 18(B) is a sectional view of such the toner supply container 1 and the staving member 25a.

Referring to FIG. 18, in order to eliminate the need for alignment at the time of mounting the toner supply container 1, the driving force transmitting rib 25b and the driving force receiving rib 12 are provided with tapered surfaces 25c and 6a at their tip portions, respectively. Further, in view of the case where the driving force transmitting rib 25a and the driving force receiving rib 12 collide with each other to fail in engagement for driving force transmission, a force applied to the staving member or the toner supply container main body so as to be distant from each other. In this case, the driving force transmitting rib is rotationally driven to finally engage with the driving force receiving rib.

In this way, the staving member is designed to engage the opening 1a at the outside of the toner supply container, so that it is possible to prevent formation of coarse toner particles at the engagement portion. Further, the driving force transmission is performed at a position distant from the rotation center of the toner supply container in a radial direction, so that torsion of the members is not caused to occur compared with the case of driving force transmission at the rotational center position. As a result, a durability of the constitutional members is improved.

FIG. 19(A) is a perspective view a toner supply container 1 provided with an opening 1a having a driving force receiving groove 13, and a staving member 26a provided with a driving force transmitting rib 26b. FIG. 19(B) is a sectional view of such the toner supply container 1 and the staving member 26a.

In the structure shown in FIG. 19, it is necessary to use an alignment means at the time of mounting the toner supply container 1. As the alignment means, it is possible to use that employed in Embodiment 1.

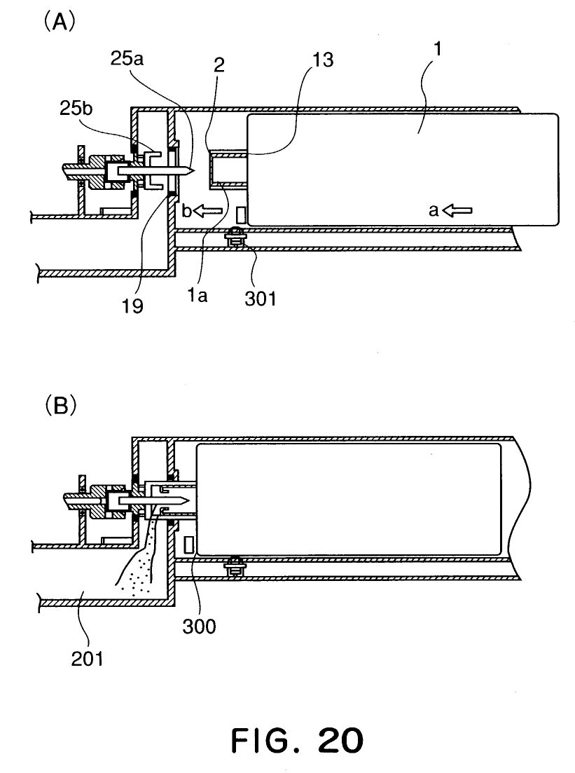

In the image forming apparatus body, a state that, in the structure of FIG. 19, the sealing member is staved and the driving force transmitting rib 26b is engaged with the driving force receiving groove 13 will be described with reference to FIG. 20.

First, the user inserts a new toner supply container 1 into the apparatus main body 100 in a direction of an arrow a shown in (A) of FIG. 20. FIG. 20(A) shows a state immediately after the insertion (mounting). As shown in (A) of FIG. 20, at one end face of the toner supply container 1, an opening 1a is provided and is in a state sealed by a sealing member 2. Thereafter, the user closes a front (exchanging) cover 15. In interrelation with this closing operation of the front cover 15, a sliding member 300 is slided to move the toner supply container 1 in a direction of an arrow b, thus staving the sealing member 2 with the staving member 26a disposed on the apparatus main body side to unseal the opening 1a. Then, the driving force receiving groove 13 on the toner supply container side and the driving force transmitting rib 26a on the apparatus main body side engage with each other, thus allowing driving force transmission.

In this state, when an unshown motor is driven, a rotational driving force is transmitted from the driving force transmitting rib 26a to the driving force receiving groove 13 of the toner supply container 1, thus rotating the toner supply container 1.

Even in the above-mentioned structures shown in FIGS. 18 and 19, similarly as in Embodiment 1, the sealing member 2 sealing the opening 1a of the toner supply container 1 is staved with reliability, and then the driving force receiving rib 12 and groove 13 are engaged with the driving force transmitting ribs 25b and 26b, respectively. As a result, it is possible to prevent such an operation that the toner supply container is driven without accidentally unseal the toner sealing member.

(Embodiment 3)

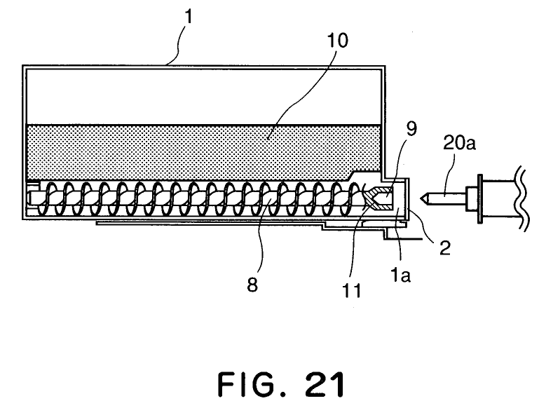

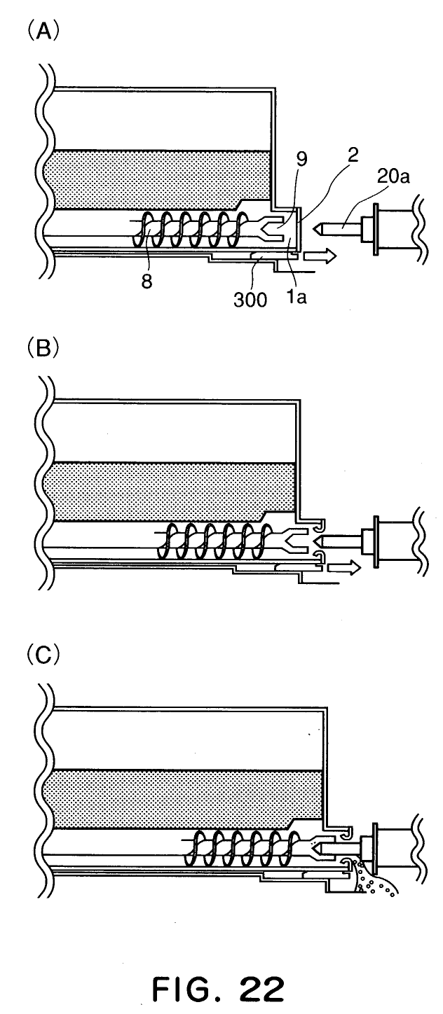

This embodiment will be described with reference to FIGS. 21 and 22.

This embodiment is characterized in that a feeding member 8 for feeding toner toward an opening 1a is provided in a toner supply container 1 as shown in FIG. 21.

The structure of the image forming apparatus main body is identical to Embodiment 1.

FIG. 21 is a sectional view of the toner supply container 1 according to this embodiment.

Referring to FIG. 21, the feeding member 8 is a so-called screw for feeding the toner and the screw is provided with an engage recess 9 at its leading end. Further, the toner supply container 1 also includes a stirring member 10 and similarly as in Embodiment 1, includes an opening 1a and a sealing member 2 which seals the opening 1a.

The staving member 20a on the apparatus main body is identical to that used in Embodiment 1.

A state of engagement of the staving member 20a with the engage recess 9 will be described with reference to FIG. 22.

FIG. 22(A) shows a state of the staving member 20a, the sealing member (screw) 2 and the engage recess 9 when the user opens the front (exchange) cover 15 of the apparatus main body 100 and sets a new toner supply container 1 in the apparatus main body 100. In this state, the staving member 20a locates on the front side of the sealing member 2, and the sealing member 2 is still in an unsealed state that the front cover 15 is not yet closed.

FIG. 22(B) shows a state of the staving member 20a, the sealing member 2 and the engage recess 9 when the front cover 15 is almost half closed and the toner supply container 1 is almost half pushed into the apparatus main body by the sliding member 300 as shown in FIG. 22. In this state, the sealing member 2 is staved by the staving member 20a to unseal the opening 1a.

FIG. 22(C) shows a state of the staving member 20a, the sealing member 2 and the engage recess 9 when the front cover is completely closed, and the toner supply container 1 is completely pushed into the apparatus main body by the sliding member 300 shown in FIG. 22. In this state, the sealing member is staved by the staving member 20a to unseal the opening 1a, and the staving member 20a is completely engaged in the engage recess 9. As shown in (C) in FIG. 22, in such a state that the staving member 20a is completely engaged in the engage recess 9, the staving member 20a is sufficiently long, so that the opening 1a and the end face of the driving force transmitting member of the apparatus main body are sufficiently distant from each other to permit supply of the toner through such a distant region.

Incidentally, in order to prevent the toner from filling the engage recess 9, the engage recess 9 is provided with a through hole 11 for permitting escape of the toner therefrom as shown in FIG. 21.

As described above, the opening 1a is unsealed, and the driving force is transmitted from the apparatus body side to the feeding member 8 of the toner supply container 1, thus rotating the feeding member 8. As a result, it is possible to supply the toner from the toner supply container 1 to the developing device 201 on the apparatus main body side through the unsealed opening 1a.

According to this embodiment, it is possible to prevent the user from accidentally rotating the coupling (engaged) portion, with reliability.

(Embodiment 4)

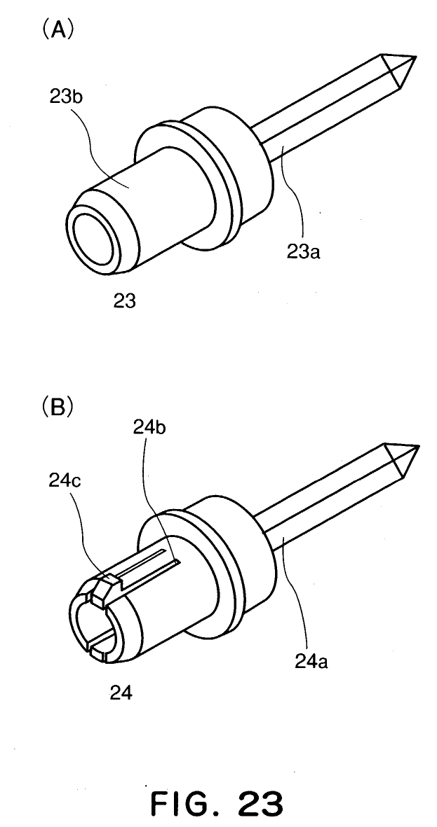

This embodiment will be described with reference to FIGS. 23-25, which illustrate shapes and structures of a driving force transmitting member provided with a transmitting member.

FIG. 23 is a perspective view of driving force transmitting members 23 and 24.

FIG. 23(A) shows the driving force transmitting member 23 includes a starting members 23 and 24.

FIG. 23(A) shows the driving force transmitting member 23 includes a staving member 23a and a mounting portion 23b for readily detachably mountable to the apparatus main body.

The transmitting member 23a is to stave the sealing member 2 which seals the opening 1a of the toner supply container 1 used in Embodiments 1 and 2 and to engage with the engage hole 3, thus transmitting the driving force from the apparatus main body to the toner supply container 1.

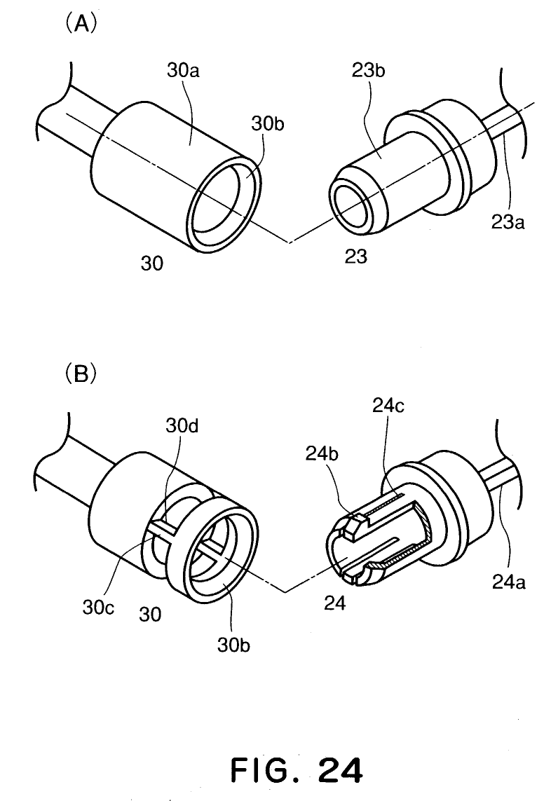

The mounting portion 23b is pressed into a mounting portion 30a of the apparatus main body along an inner peripheral surface of the main body-side mounting portion 30a , thus being locked in a rotational axis direction and in a rotational direction (FIG. 24(A)).

FIG. 23(B) shows the driving force transmitting member 24 including a staving member 24a, a slit 24b and a main body mounting rib 24c, which form a snap-fit structure.

The staving members 23a and 24a have the same function as the staving member shown in (A) of FIG. 20.

Referring to (B) of FIG. 23, the main body mounting rib 24c can be bent inward (in a central axis direction) and is coupled to a driving portion 30 of the apparatus main body in a snap fitting manner so as to be readily detachable from the driving portion (FIG. 24(B)).

The coupling of the driving force transmitting members 23 and 24 with the driving portions 30 will be described with reference to FIG. 24, wherein (A) is a perspective view corresponding to (A) of FIG. 23, and (B) is a perspective view corresponding to (B) of FIG. 23.

Referring to (A) of FIG. 24, the mounting portion 23b of the driving force transmitting member 23 in simply pressed and fixed into the mounting portion 30a on the apparatus main body side. Further, the main body-side mounting portion is provided with a tapered surface 30b at its inner leading end portion, thus allowing smooth coupling.

Referring to (B) of FIG. 24, the driving portion 30 of the apparatus main body has a tapered surface 30b, n engage rib 30c and an engage portion 30d.

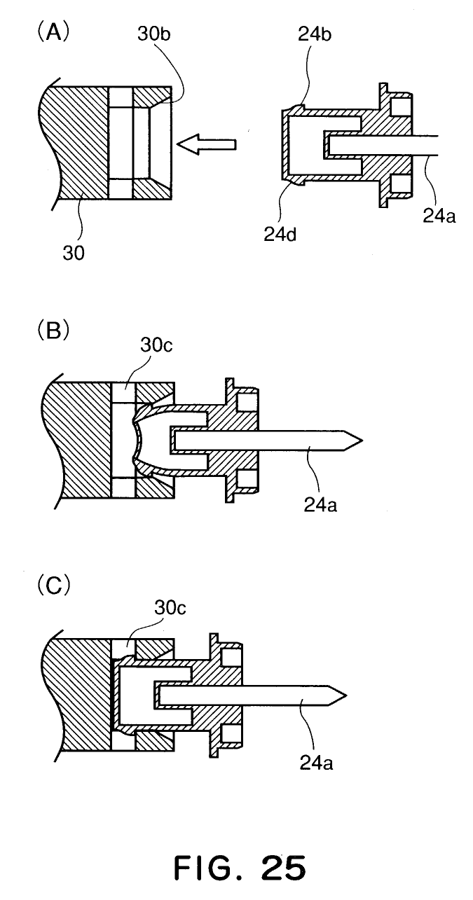

A state of mounting the driving force transmitting member 24 into the driving portion 30 will be described in detail with reference to FIG. 25.

FIG. 25(A) shows a state of the driving force transmitting member 24 to be inserted into the driving portion 30 of the apparatus main body so as to set the transmitting member 24 in the driving portion. In this state, the transmitting member 24 is not yet engaged in the driving portion 30 of the apparatus main body.

When the driving force transmitting member 24 is further inserted, as shown in (B) of FIG. 25, the mounting rib 24b provided to the driving force transmitting member 24 contacts the tapered surface 30b and is guided along the tapered surface 30b to be elastically deformed and inserted into the driving portion 30 while being gradually bent inward.

When the insertion further proceeds, as shown in (C) of FIG. 25, the bending of the mounting rib 24b after passing through a straight portion of the driving portion 30 is released at a space free from the engage rib 30c. At the space, the mounting rib 24b is placed in a engagement state with the main body-side driving portion 30. In this state, the mounting rib 24b is securely engaged in the driving portion 30 to be placed in a state that a position of the mounting rib 24b in a thrust (axis) direction. When the apparatus main body-side driving portion 30 is rotated, the driving portion 30 engaged with the driving force transmitting member 24 also in the rotational direction to permit driving force transmission.

In this way, the driving portion of the apparatus main body is fixed with the driving force transmitting member of this embodiment so as to permit driving force transmission, whereby it becomes possible to transmit the driving force from the apparatus main body to the toner supply container.

As described above, the driving force transmitting member provided with the staving member is designed to be readily detachably mountable to the main body of the image forming apparatus, whereby it is possible to simplify the replacement of the toner supply container even if a square shank portion as the driving force transmitting member is rounded with time to fail in good driving force transmission or a sharp tip potion of the driving force transmitting member is blunted with time.

According to the above-described embodiments, the following effects are achieved. It is possible to obviate an operation such that the feeding member of the toner supply container or the container body is driven without accidentally unsealing the toner supply container.

It is possible to reduce the unsealing force by the use of the resin film as the sheet (sealing member). This effect can be further improved by providing the sheet with the easy cut portion. The easy cut portion can enlarge an opening region of the toner discharge port as large as possible.

The sheet exhibits shrinking property when it is staved, so that it becomes possible to enlarge an opening region of the toner discharge port as large as possible. Accordingly, it is possible to stably discharge toner without any obstruction.

What is claimed is:

1. A toner supply container detachably mountable to an image forming apparatus, comprising:
a container body for accommodating toner,
a discharge opening for permitting discharge of the toner from said container body,
a sheet for sealing said discharge opening and for being staved by an unsealing member provided in the image forming apparatus, and
a rotational force receiving portion for receiving a rotational force for feeding the toner from said container body toward said discharge opening,
wherein after said sheet is staved by the unsealing member, said rotational force receiving portion is engaged with said unsealing member to be placed in a state capable of receiving the rotational force.

2. A container according to claim 1, which further comprises a spout extended from a part of an end face of said container body, said spout is provided with said discharge opening at its end portion.

3. A container according to claim 2, wherein said rotational force receiving portion is provided in said spout.

4. A container according to claim 1, which further comprises a feeding member for feeding the toner from said container body toward said discharge opening by rotating said container body by the rotational force received by said rotational force receiving portion.

5. A container according to claim 1, which further comprises a feeding member for feeding the toner from said container body toward said discharge opening by rotating itself against said container body which is non-rotatably held by said image forming apparatus.

6. A container according to claim 1, wherein the sheet is a resin film.

7. A container according to claim 6, wherein the sheet is provided with an easy cut portion.

8. A container according to claim 7, wherein the easy cut portion comprises a perforated or linear recess provided to the resin film.

9. A container according to claim 1, wherein the sheet has a property of being shrunk when the sheet is staved by said unsealing member.

10. An unsealing member, provided to an image forming apparatus, for unsealing a toner supply container which comprises a container body for accommodating toner, a discharge opening for permitting discharge of the toner, and a sheet for sealing the discharge opening, comprising:
a staving member for staving the sheet, and
a coupling portion for being engaged with the toner supply container in order to transmit a rotational force for feeding the toner from the container body toward the discharge opening.

11. A member according to claim 10, wherein said staving member staves in the sheet to unseal the discharge opening and then said coupling portion engages with the toner supply container.

12. A member according to claim 11, wherein said coupling portion engages with a portion to be coupled provided in the container body.

13. A member according to claim 12, which further comprises a bar-shaped member provided with said staving member at its end portion, said staving member being pointed.

14. A member according to claim 13, wherein said coupling portion is provided in a state capable of being rubbed with said sheet at a peripheral surface of the bar-shaped member.

15. A member according to claim 13, wherein the bar-shaped member is provided with a hollow constituting a discharge passage of the toner.

16. A member according to claim 13, wherein the bar-shaped member has a noncircular cross section corresponding to a shape of a hole provided in the toner supply container.

17. A member according to claim 10, wherein there are provided a plurality of such staving members.

18. A member according to claim 10, which further comprises a snap fit mounting portion for detachably mounting the unsealing member in the image forming apparatus.
